(19) United States
(12) Patent Application Publication
(10) Pub. No.: US 2005/0245636 A1
(43) Pub. Date: Nov. 3, 2005

(54) Radiation-curable coatings for wood substrates from multifunctional acrylate oligomers

(75) Inventors: Robert B. Fechter, Worthington, OH (US); Michael Gould, Powell, OH (US); Thomas L. Marino, Toledo, OH (US); Alexandre Mejiritski, Bowling Green, OH (US); Dustin B. Martin, Monroe, MI (US)

Correspondence Address: CONNOLLY BOVE LODGE & HUTZ LLP, SUITE 800, 1990 M STREET NW, WASHINGTON, DC, 20036-3425, US

(73) Assignee: Ashland Inc., Ashland, KY (US)

(21) Appl. No.: 10/834,176

(22) Filed: Apr. 29, 2004

(51) Int. Cl. C08G 2/00

(52) U.S. Cl. 522/178

(57) ABSTRACT

The invention detailed herein comprises a family of radiation-curable coating formulations specifically for wood substrates. These coating formulations are based on multifunctional acrylate resins formed by the reaction of acrylate monomers and oligomers with β-keto esters (e.g., acetoacetates), β-diketones (e.g., 2,4-pentanedione), β-keto amides (e.g., acetoacetanilide, acetoacetamide), and/or other β-dicarbonyl compounds that can participate in the Michael addition reaction. These coating resins will cure under standard UV-cure conditions without the addition of traditional photo initiators.

### FIELD OF THE INVENTION

The present invention relates generally to a family of radiation-curable coatings specifically for wood substrates. These inventive coatings are based on multifunctional acrylate resins formed by the reaction of acrylate monomers and oligomers with β-keto esters (e.g., acetoacetates), β-diketones (e.g., 2,4-pentanedione), β-keto amides (e.g., acetoacetanilide, acetoacetamide), and/or other β-dicarbonyl compounds that can participate in Michael addition reactions. The Michael resins of the present invention are synthesized from monomers and oligomers chosen to yield surface tensions matched to the surface energies of wood substrates and that have moieties that may participate in hydrogen bonding and other Lewis acid/base forces to promote good matrix-substrate adhesion as well as good matrix cohesive integrity.

### BACKGROUND

The information provided below is not admitted to be prior art to the present invention, but is provided solely to assist the understanding of the reader.

Acrylate, methacrylate and other unsaturated monomers are widely used in coatings, adhesives, sealants, and elastomers, and may be crosslinked by ultraviolet (UV) light in the presence of photoinitiators or by peroxide-initiated free radical cure. These photoinitiators and/or peroxides are typically low molecular weight multifunctional compounds that may be volatile or absorbed through skin that may cause adverse health effects. Functionalized oligomeric or polymeric photoinitiators may overcome some of these drawbacks; generally, polymeric photoinitiators are nonvolatile compounds, not readily absorbed through skin. However, multistep syntheses may be required, low functionality may be detrimental to reactivity and final properties, and catalyst or initiator may still be required to effect crosslinking.

The novel coatings disclosed here exhibit performance properties that make them very effective across a range of wood substrates. Traditionally, to modify the properties of photoinitiator-containing coating formulations one must admix additives, including reactive monomers and oligomers. Traditional additives can confer higher cost and may compromise some performance attributes. However, the specific properties of the coatings resulting from the present invention can be extensively modified merely by varying oligomer composition alone. Coating films can be engineered to exhibit wide ranges of hardness, toughness, flexibility, tensile strength, stain resistance, scratch resistance, impact resistance, solvent resistance, etc. Almost any desired coating performance parameter can be attained by proper selection of the raw material building blocks used to make the oligomer.

Cure of conventional polyacrylate coating systems may be achieved without a UV photoinitiator. However, such systems require the use of a more expensive, high-energy source, such as electron beam (EB) radiation, and cannot be accomplished with much cheaper radiation. The resins and coatings of the present invention can be fully cured with UV radiation with little or no traditional photoinitiator.

Multifunctional acrylates and methacrylates are commonly utilized in the preparation of crosslinked films, adhesives, foundry sand binders, and other composite materials. The invention disclosed herein demonstrates the advantageous use of these uncrosslinked resins alone or modified by reaction/blending with additional materials in coatings applications on a variety of wood substrates. These additional materials include a variety of acrylic monomers and oligomers, primary and secondary and tertiary amines, acid-functional materials, siloxanes, elastomers, waxes and others to modify and improve coatings performance.

Coatings for wood substrates based on the resins described above can be cured by all methods typically used to crosslink acrylic materials. Cure, or crosslinking, is usually accomplished through a free radical chain mechanism, and may be induced by any of a number of free radical-generating species such as peroxides, hydroperoxides, REDOX combinations, and other materials that decompose to form radicals, either when heated, or at ambient temperature in the presence of an amine or a transition metal promoter. Ultraviolet and electron beam radiation are alternative means of initiating reaction by decomposing an appropriate initiating species to form free radicals.

The coatings described in this invention offer significant advantages over coatings based on traditional multifunctional acrylic monomers and oligomers in that they can be cured by exposure to UV radiation without the addition of a photoinitiator. Under typical UV curing conditions (˜500 mJ/cm²), these coatings can be effectively cured on a variety of wood substrates with little or no added photoinitiator. Traditional multifunctional acrylates and/or oligomers will not cure upon exposure to UV radiation unless a photoinitiator, often at relatively high levels, is added to coating formulations. Traditional photoinitiators (e.g., benzophenone) can be toxic and expensive. An additional disadvantage is that photoinitiators and/or their decomposition products may contribute to film color, which can limit applicability of the coating over white and light-colored substrates.

A coating must adequately wet out the surface of a substrate for it to adhere well to that surface. There are three principle wetting phenomena that apply to coatings: spreading, adhesional, and penetrational or immersional wetting. Spreading and adhesional wetting directly impact the application of a coating to a particular surface. Penetrational or immersional wetting impacts the application of coatings to porous surface structures and to particulate dispersions. When a coating fluid wets a surface, a second fluid, usually air, is displaced. Surface tension, both of the coating fluid and of the substrate, controls the action of wetting.

The spreading of a liquid over a solid is defined by S_{L/S}=λ_{SA}−(λ_{LA}+λ_{SL}), where, λ_{SA} denotes the surface tension of the substrate under air, λ_{LA} denotes the surface tension of the liquid coating under air, and λ_{SL} denotes the interfacial tension or free energy of the substrate/liquid coating interface. A coating fluid will spread spontaneously when S_{L/S} is either positive or zero. Where S_{L/S} is negative, the coating will not properly wet the substrate. The resultant coating will be characterized by pinholes, fisheyes, or picture framing, and in the worst case scenario, complete de-wetting (‘beading’) will occur. The substrate-air surface tension cannot be controlled by the resin designer and the substrate-coating interfacial tension is assumed to be a minimum when the surface tensions of the substrate and coating fluid are nearly identical. Therefore, for best wetting, the coating surface tension should be lower than, but approximate equal to the surface energy of the substrate. Hardwoods, such as yellow poplar and red oak, have surface energies in the range of from about 55 to about 70 dynes/cm.

The term adhesion refers to the attraction that molecules of one material experience towards molecules of a different material. The attraction of molecules of one material towards other molecules of the same material is cohesion. The surface tension of a liquid is a measure of its cohesion. The analogous term for a solid is surface energy. Surface tension and surface energy have the same units (dynes/cm) and surface tension is often used interchangeably to refer to the liquid or solid state. The Lewis acid/base theory is the current state of the art in understanding adhesive phenomena. Atoms are held in larger structures called molecules by two types of bonds: ionic and covalent. Similarly molecules are held in larger structures (liquids and solids) by cohesive and adhesive forces termed intermolecularforces. Approximately twenty such forces are known, most are insignificant and may be ignored to a first approximation. The dominant forces are primarily electrostatic. The theory divides intermolecular forces into two principal groups. The various names have fine shades of meaning, but are normally used interchangeably: a) LW=Liftshitz-van der Waals≈London≈non-polar≈dispersive forces; and b) AB=(Lewis) acid/base≈polar forces. Dispersion forces are always present, but acid/base forces, which may or may not be present, contribute most to industrial adhesion. In particular, adhesion to wood will be dominated by hydrogen bonding to cellulosic constituents.

A need therefore exists for UV-curable wood coating resins that have surface tensions in a range matched to the surface energy of wood and that have moieties that may participate in hydrogen bonding and other Lewis acid/base forces.

Other objects and advantages will become apparent from the following disclosure.

### SUMMARY OF INVENTION

An aspect of the present invention provides resin formulations and coating compositions that cure under standard UV-cure conditions without the addition of traditional photoinitiators.

The present invention provides UV-curable Michael resins comprising polar-functionalized polyacrylates, β-dicarbonyl compounds, and, optionally, secondary amines. According to an aspect, Michael addition resins are provided which contain a substantial proportion of acrylates bearing hydrogen-bonding groups, e.g. hydroxyl, epoxy, amine, acid, urethane, melamine, ether, ester, and mixtures thereof. According to a further aspect of the present invention, the Michael resin may further comprise an amine-modified polyether multifunctional acrylate.

According to an aspect, the present invention provides UV-curable resins that have surface tensions in a range matched to the surface energies of wood and that have moieties that may participate in hydrogen bonding and other Lewis acid/base interactions with polar functional groups of wood. According to a further aspect of the invention, wood sealer and wood filler compositions, based on the inventive resins, are provided According to yet a further aspect, topcoat compositions are provided. The topcoat resins have surface tensions approximating that of the sealer and filler resins ensuring good wetting of cured sealer and/or filler films. The topcoat resins also are composed of moieties that may participate in hydrogen bonding and other electrostatic interactions with the Lewis-functional groups of the sealer and filler resins.

An aspect of the present invention provides wood filler compositions comprising the inventive resin blended with particulate fillers to mask imperfections in the substrate surface. A wood filler is optimized to contact a wood substrate. A wood filler preferably has a surface tension in the range of from about 50 to about 60 dynes/cm in order to approximate, but be slightly less than the surface energy of wood. The inventive wood filler comprises acrylates having Lewis-functional groups in the range of from about 0.5 to about 1.5 moieties per 100 molecular weight.

An aspect of the present invention provides wood sealer compositions comprising the inventive resin. A wood sealer is optimized to contact a wood substrate. A wood sealer preferably has a surface tension in the range of from about 50 to about 60 dynes/cm in order to approximate, but be slightly less than the surface energy of wood. The inventive wood sealer comprises acrylates having Lewis-functional groups in the range of from about 0.5 to about 1.5 moieties per 100 molecular weight.

A further aspect provides a topcoat comprising the inventive resin that may be blended with agents to impart toughness, scuff and mar resistance, and color.

An aspect of the present invention provides a method of using the inventive composition comprising applying the composition to a substrate, preferably, but not necessarily wood, and curing the composition.

An aspect of the present invention provides a wood surface coated with a Michael resin of the present invention. A further aspect provides a device loaded with the inventive resin composition.

### BRIEF DESCRIPTION OF DRAWINGS

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 shows trimethylol propane triacrylate (TMPTA) reacted with ethyl acetoacetate (EAA), in a 2:1 molar ratio, in the presence of 1,8-diazabicyclo[5.4.0]undec-7-ene (DBU) to yield a four-functional polyacrylate oligomer having dual chemical functionality.

FIG. 2 depicts the reaction of a Michael resin with a secondary amine.

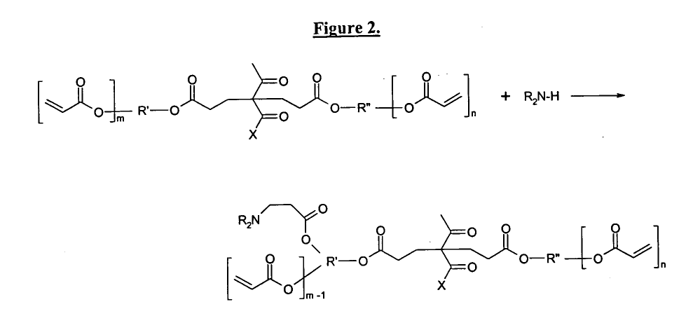

It is to be noted, however, that the appended drawings illustrate only typical embodiments of this invention and are therefore not to be considered limiting of its scope, for the invention may admit to other equally effective embodiments.

### DETAILED DESCRIPTION OF A PREFERRED EMBODIMENT

Reference is made to the figure to illustrate selected embodiments and preferred modes of carrying out the invention. It is to be understood that the invention is not hereby limited to those aspects depicted in the figure.

The term “wood sealer” comprehends resins and compositions applied to a wood substrate to penetrate into and seal the pore structure of wood. Sealers act to stop further absorption of successive coats into the wood, thus helping successive coats to level. Sealers permit smooth, uniform coverage of later-applied topcoats. Wood sealers are characterized by good penetration and sealing of pore structures and good sandability. Wood sealers are also characterized by good adhesion to wood substrates, to topcoats, and to wood fillers.

The term “wood filler” comprehends resins and compositions applied to a wood substrate to penetrate into and fill and seal deep pores and to fill surface roughness. Wood fillers are characterized by high viscosity for easy filling of deep imperfections, good adhesion to wood and to coatings or applied paper or foil veneers. Wood fillers are sandable, hard and durable, and usually contain a particulate filler material to add body, to harden the cured coating, to increase the coating sandabilty, and to lower cost. The term “particulate filler” comprehends an inert solid particulate material that is blended in with a resin to increase viscosity, to make the resin more sandable after cure, and lower the total cost of the formulation.

The term “topcoat” comprehends resins and compositions applied to a surface coated with a cured wood sealer. Topcoats are characterized by surface tensions matched to that of wood sealers over which they are to be applied. Topcoats also comprise Lewis-functional moieties enabling electrostatic interaction with similar groups in wood sealers. Topcoats are used to give uniform, smooth, durable, and aesthetically appealing finishes. Topcoats provide finishes that are hard and durable, and mar, scratch, and chemical resistant.

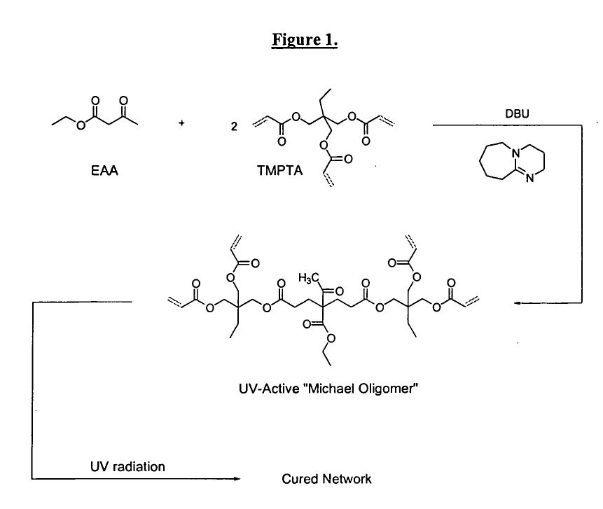

FIG. 1 shows the reaction of a Michael acceptor, the multifunctional (F=6) acrylate trimethylol propane triacrylate (TMPTA) reacted in a 2:1 molar ratio with a β-ketoester Michael donor, ethyl acetoacetate (EAA), in the presence of a base catalyst, 1,8-diazabicyclo[5.4.0]undec-7-ene (DBU). The resulting four-functional (F=4) polyacrylate Michael oligomer has dual chemical functionality. That is, it has both acrylic functionality and a labile ketone group that is capable of dissociating to initiate free radical polymerization of the oligomer upon exposure to UV radiation.

As applied to radiation-curable resins and coating compositions, the term “UV” is intended, generally, to include the various types of radiation used to cure such resins such as broad spectrum UV/visible, visible, ultraviolet (UV), and electron beam (EB) radiation.

An “oligomer” of the present invention may be compared with a “resin” of a classical coating. For lexicographical convenience, the present disclosure uses “Michael resin,” “Michael addition product,” and “Michael oligomer” as equivalent and interchangeable terms.

The term “epoxy acrylate” refers to the reaction product of an epoxy-containing compound and acrylic or methacrylic acid. As is known, acrylic acid or methacrylic acid react with an epoxide in a ring-opening reaction to form a β-hydroxyalkyl acrylate ester. An epoxy acrylate does not necessarily contain any epoxide rings.

The term “Lewis-functional” refers to chemical moieties that can participate in hydrogen-bonding and/or other electrostatic interactions. Lewis-functional groups include, but are not limited to hydroxyl, epoxy, amine, acid, urethane, melamine, ether, and ester (including acrylate ester).

The term “wood substrate” is defined to mean a surface comprised of wood and/or a surface coated with a film that wets and adheres to wood.

The present invention confers an advantage in not requiring solvents for effective application to substrates. However, the high selectivity of the Michael reaction permits the use of monomers such as styrene and methyl methacrylate as reactive diluents, inert in the Michael reaction, to give low-viscosity systems that are easily incorporated into a variety of laminating resins. Suitable, non-limiting, non-reactive solvents include styrene, t-butyl styrene, cl-methyl styrene, vinyl toluene, vinyl acetate, allyl acetate, allyl methacrylate, diallyl phthalate, C₁-C₁₈-methacrylate esters, dimethacrylates, trimethacrylates and vinyl ethers.

The present invention provides a resin having residual pendant unsaturated acrylate groups. Residual pendant unsaturation means that polymerizable acrylic groups are retained by means of careful control of the reactant stoichiometry during the Michael reaction. That is, there are more acrylic groups than reactive sites on the Michael donor. The nature of that addition reaction leaves pendant (versus present as part of the “backbone” of the structure where it is attached on two sides) acrylic groups away from the site of the Michael addition. Those acrylic groups are available for free radical polymerization, further Michael addition crosslinking or “pseudo Michael addition” reactions, e.g., with amines, or thiol-ene additions with mercaptans after UV exposure.

The properties of films formed upon UV irradiation can be modified in a number of ways including use of additional or supplementary acrylate materials, substituting the Michael donor with any number of different β-dicarbonyl compounds, and/or by simply varying the stoichiometry of the reactants. The resulting films can be made to be softer, to be more flexible, to exhibit less shrinkage, and to have greater adhesion to a variety of wood substrates than films yielded by traditional acrylate monomer/photoinitiator “syrups”. Coatings based on these novel multifunctional acrylate resins exhibit excellent adhesion and shrinkage control, flexibility, solvent resistance, scratch and mar resistance, impact resistance, color, and durability across a wide range of wood materials. These coatings may be cured via chemical means, thermally, or by exposure to UV or electron beam radiation.

Systems comprised of traditional monomers and oligomers often have compatibility issues with some additives, conventionally used in the coatings arts, thus providing for fewer formulating options. However, formulations built from the novel photo-curable oligomer resins described herein can incorporate nearly an unlimited variety of additives due to the chemical/architectural control possible in their synthesis. Thus, many more options are available to the formulator who must address specific challenges (e.g., adhesion, flexibility, color, etc.) for each particular wood substrate.

The coating formulations described in the following examples can be diluted or “reduced” with common solvents, for spray application to substrates, or applied at 100% solids by any means consistent with the shape and constitution of the substrate article. Unless otherwise noted, films were produced by applying resin to various substrates using a wet-film applicator. Cure was accomplished by exposure to a specified single mercury vapor lamp at the specified intensity and dose.

The present invention varies the acrylate, Michael donor and “amine cap” components of the resin to balance the surface tension of the composition—responsible for substrate wetting—against the electrostatic properties—responsible for the adhesive properties. Generally, acrylate monomers have surface tensions in the range of about 30 to 40 dynes/cm. These values are approximately 10 to 20 dynes/cm lower than optimal for wood substrates. Providing acrylates having Lewis-functional groups acts both to raise the resin surface tension and to provide adhesive potential.

In general, any acrylate monomer or oligomer may be used as part of a mixture, so long as the resultant resin has surface tension and Lewis-functional group density within a suitable range. Polyether acrylates are desirable as part of a mixture of acrylates. Ethoxylated trimethylolpropane triacrylate and ethoxylated pentaerythritol teraacrylate are preferred, but non-limiting, polyether acrylates.

In a preferred embodiment, a portion of the polyether acrylate is present as an amine-modified polyether acrylate. Polyether acrylates reduce formulation viscosity, help adhesion to wood, and add flexibility to cured coatings. Amine-modification of acrylates, in general, enhances UV cure response, primarily by overcoming oxygen inhibition. Such modified acrylates are said to have built-in amine synergist. Preferred, but non-limiting, amine-modified polyether acrylates include Genomer 3497™ and Genomer 3364™ (Rahn USA Corp). Amine-modified polyether acrylates are known to persons of skill in the coatings formulary arts and suitable alternatives may readily be chosen.

In an embodiment, tertiary amines are introduced into the resin by reacting secondary amines with a portion of the acrylate functionalities. Incorporation of amines increases cure response and provides Lewis-functional moieties. The secondary amine is added to the β-dicarbonyl/acrylate mixture at a preferred molar ratio of 0.18 moles amine per mole dicarbonyl. A preferred secondary amine is diethanolamine. Suitable, non-limiting, secondary amines include piperidine, diethylamine, di-n-butylamine, morpholine, N-methylethanolamine, piperazine, and mixtures thereof. Likewise, addition of a primary amine to the polyacrylate resin results in formation of a tertiary amine by successive additions of the amine to acrylate double bonds. In so doing, the amine acts as a “linking point” for two acrylate monomers or oligomers, thus increasing the resin viscosity. While this may have some efficacy in certain circumstances, it is generally more desirable to utilize a secondary amine and thus limit viscosity-building chain extension. Preferred primary amines include butlyamine, monoethanolamine and N-(aminoethyl)piperidine.

The various compounds listed above may be added in any order, but it is preferred to add the amine following synthesis of the resin.

In a preferred embodiment, a portion of the acrylate is present as a polyester acrylate. Polyester acrylates provide good adhesion to wood—particularly desirable in wood sealers—and provide hardness, mar resistance, and chemical resistance to cured coatings—particularly desirable in top-coat resins. Preferred, but non-limiting, polyester acrylates include Ebecryl 810™ (Surface Specialties Division of UCB Chemicals), CN292 (Sartomer Company) and Laromer PE 55 F (BASF AG). Polyester acrylates are known to persons of skill in the coatings formulary arts and suitable alternatives may readily be chosen.

In a preferred embodiment, a portion of the acrylate is present as an epoxy acrylate. It is preferred that the epoxy acrylate be aromatic. Prefered, but non-limiting, epoxy acrylates include epoxy novolac acrylates, bisphenol A epoxy diacrylate and “advanced” (higher molecular weight) bisphenol A diacrylates. Aromatic epoxy acrylates, which are generally oligomeric, offer good adhesion to wood and provide hardness and mar and chemical resistance to cured coatings.

In a preferred embodiment, a portion of the acrylate is present as a urethane acrylate. Urethane acrylates provide adhesion to wood, coating flexibility, and scratch mar, and chemical resistance. As is known to the art, urethane acrylates are available commercially. Moreover, as is known, urethane acrylates may be readily synthesized in-situ from polyisocyanates, polyether and polyester polyols, and hydroxyl-containing acrylate esters. Preferred, non-limiting hydroxyl-containing acrylate esters include 2-hydroxyethyl acrylate and caprolactone acrylate (e.g., Tone M100 from Dow).

In a preferred embodiment of a wood sealer resin composition, a portion of the acrylate is present as a low molecular weight (less than about 600 MW) multi-functional acrylate. Embodiments that incorporate particulate fillers, which block UV penetration, will experience decreased depth of cure. To compensate, a low molecular weight multi-functional acrylate, providing a high crosslink density, may be added. A preferred, but non-limiting, low molecular weight multi-functional acrylate is di-trimethylolpropane tetraacrylate.

The acrylate mixture is blended with a β-dicarbonyl compound at a preferred molar ratio of 2.6 moles total acrylate to 1.0 mole dicarbonyl. The useful ratio may vary from about 2.0 to about 4.0. The β-dicarbonyl may comprise any combination of β-keto esters, β-diketones, β-keto amides, or β-ketoanilides. A preferred, but non-limiting, β-keto ester is ethyl acetoacetate (EAA). A preferred, but non-limiting, β-diketone is 2,4-pentanedione. Preferred, but non-limiting, β-keto amides include acetoacetamide and acetoacetanilide.

The Michael addition reaction is catalyzed by a strong base. A preferred base is diazabicycloundecene (DBU), which is sufficiently strong and is readily soluble in the monomer mixtures. Other cyclic amidines, for example diazabicyclononene (DBN) and guanidines, for example, 1,1,3,3-tetramethyl guanidine, are also suitable for catalyzing this addition reaction. Group I alkoxide bases such as potassium tert-butoxide, provided they have sufficient solubility in the reaction medium, are typically adequate to promote the desired reaction. Quaternary hydroxides and alkoxides, such as tetrabutyl ammonium hydroxide or benzyltrimethyl ammonium methoxide, comprise another class of preferred base catalysts to promote the Michael addition reaction. Finally, strong, organophilic alkoxide bases can be generated in situ from the reaction between a halide anion (e.g., quaternary halide) and an epoxide moiety. Such in situ catalysts are disclosed in pending application Ser. No. 10/255,541 assigned to Ashland, Inc., the assignee of the present application.

Resin performance properties were measured by a variety of test methods familiar to those skilled in the art.

Solvent Resistance. Solvent resistance is the ability of a coating to resist solvent attack or film deformity. Rubbing the coating with a cloth saturated with an appropriate solvent is one way to assess when a specific level of solvent resistance is achieved. All rubbing tests were conducted using methyl ethyl ketone (MEK) and employed a double rub technique, one complete forward and backward motion over the coated surface. To normalize test strokes, cheesecloth was fixed to the round end of a 16-oz. ball peen hammer. The double rub technique utilizes the weight of the hammer as the operator holds the hammer at the base of the handle. This test was performed to a maximum of 200 double rubs or until the double rubbing action cut into the film or a noticeable film disorder was evident and the number of double rubs was recorded. The method is modified from the procedure of ASTM D5402.

Cross-Hatch Adhesion to wood substrates was measured according to ASTM D 2359. The test reports values OB to 5B; OB being a total failure and 5B comprises excellent adhesion. The test protocol employed two grades of tape: 1) A “standard” grade, Permacel 99; and 2) 3M 600 (“aggressive”).

Sward Hardness. The surface hardness of the cured resin coatings was measured using a Sward-type hardness rocker following the method of ASTM D2134.

Pencil Hardness. The hardness of cured resin coatings was also measured by the pencil test method of ASTM D3363. The test reports values ranging from 6B (softest) to 6H (hardest).

### EXAMPLE 1

### Wood Coating Formulations of Michael Resins Cured in Air

Acrylate-containing Michael oligomers may be synthesized by reacting an acrylate mixture with a β-dicarbonyl compound in the presence of a base catalyst. The Michael oligomers thus synthesized may then be further reacted with a secondary amine to form tertiary amine-capped Michael oligomers. A preferred mixture of acrylates contains at least one polyether acrylate, an amine-modified polyether acrylate, and a polyester acrylate in a molar ratio of 0.35/0.50/0.15. The molar ratio of any component of the mixture may vary. Example polyether acrylate-containing Michael oligomers include those designated 7037-102, 7037-107, and 7077-103. (See Table I).

TABLE I
Resins for Wood Substrates.

| | Resin | | | |
|---|---|---|---|---|
| | 7037-102 | 7037-107 | 7009-003 | 7077-103 |
| | Molar | Molar | Molar | Molar |
| Component | Ratio | Ratio | Ratio | Ratio |
| Acrylates | | | | |
| ethoxylated₃ | 0.35 | 0.15 | — | 0.35 |
| trimethylolpropane | | | | |
| triacrylate I | | | | |
| ethoxylated₄ | — | 0.25 | — | — |
| pentaerythritol | | | | |
| tetraacrylate (d) | | | | |
| di-trimethylolpropane | — | — | — | 0.50 |
| tetraacrylate | | | | |
| amine-modified | 0.50 (a) | 0.35 (b) | — | — |
| polyether acrylate | | | | |
| polyester acrylate | — | — | 0.125 | — |
| (f) | | | | |
| polyester tetraacrylate | 0.15 | — | — | 0.15 |
| (Ebecryl 810) | | | | |
| bisphenol A epoxy | — | 0.25 | — | — |
| diacrylate (e) | | | | |
| hexanediol diacrylate | — | — | 0.875 | — |
| Total acrylate:β- | 2.6:1.0 | 2.6:1.0 | 2.6:1.0 | 2.6:1.0 |
| dicarbonyl (2.6:1.0) | | | | |
| β-Dicarbonyls | | | | |
| 2,4-pentanedione (PD, | 1.0 | 1.0 | 1.0 | 1.0 |
| β-diketone) | | | | |
| Amines | | | | |
| diethanolamine (DEA) | 0.18 | 0.18 | — | 0.35 |
| Piperidine | — | — | 0.36 | — |
| Oligomer Functionality | 4.6 | 3.6 | 2.0 | 4.7 |
| Viscosity (cP @ 25° C.) | 1800 | 3940 | 7440 | 4750 |

(a) Genomer 3497;
(b) Genomer 3364;
(c) SR454;
(d) SR494;
(e) XZ 92551.00;
(f) Laromer PE 55 F.
Acrylate molar ratio is relative to total acrylate; amine and dicarbonyl ratios normalized to dicarbonyl.

Comparative Formulation A (Table II) serves as a “benchmark” formulation against which to compare the performance of the coating compositions of the present invention containing the inventive Michael resins. Formulation A accurately reflects the composition of UV Curable, Non-Yellowing Wood Coating (Sartomer Application Publication #4019). Formulation A is composed of commercial raw materials, in parts by weight, as specified in Table II and accurately represents the current state of the art.

Oligomers and monomers were blended in parts by weight, as noted in Table IV. Formulation viscosities were measured and deemed acceptable so long as they approximated that of the comparative formulation, and the formulations could be applied by conventional wet film applicator equipment. Coatings were applied in two, 2-mil thick layers over red oak and poplar substrates. Each layer was separately cured in air using a Fusion 300 W/in. “H” bulb at the indicated dose and intensity. Dosage was quantified with an International Light IL 393 radiometer, measuring total UV-A and -B radiation between 250 and 400 nm. All physical tests were performed on fully cured, tack-free coatings.

TABLE II
Conventional UV-Cure, Non-Yellowing Wood Coating

| Raw | | Parts | Viscosity |
|---|---|---|---|
| Material | Description | (w/w) | (cP @ 25° C.) |
| CN964E75 | Aliphatic urethane diacrylate, | 49.9 | 1495 (60° C.) |
| | diluted with 25% SR454 | | |
| SR306 | Tripropylene glycol diacrylate | 12.0 | 15 |
| SR344 | Polyethylene glycol (400) | 7.0 | 57 |
| | diacrylate | | |
| SR454 | Ethoxylated₃ trimethylolpropane | 9.0 | 60 |
| | triacrylate | | |
| SR9003 | Propoxylate₂ neopentyl glycol | 11.0 | 15 |
| | diacrylate | | |
| SR399 | Dipentaerythritol tetraacrylate | 3.0 | 13600 |
| SR1129 | photoinitiator | 5.0 | — |
| SR1137 | photoinitiator | 3.0 | — |

Table IV compares the properties of two preferred embodiments of the inventive Michael resins, Formulations B and C, against comparative Formulation A. The inventive Michael resin embodied in B is suitable for use as a coating without further additions. Formulation B confers the advantage of UV-cure in the absence of added photoinitiator. Alternatively, Formulation B may be cured in the presence of low amounts of added photoinitiator using reduced radiation doses.

An alternative Michael resin, embodied in Formulation C, is preferably used with the addition of a portion of a bisphenol A epoxy diacrylate oligomer.

The adhesion test performance of Formulations B and C was better than that of the comparative “standard.” Formulations B and C performed indistinguishably from the standard on the remaining tests. Moreover, the inventive formulations based on oligomers 7037-102 (B) and 7037-107 (C) both delivered tack-free cure at 310 and 345 mJ/cm², respectively, with ⅛th the photoinitiator loading of the comparative standard. To achieve tack-free cure, comparative formulation A required 440 mJ/cm² of UV radiation even utilizing the full photoinitiator package. Formulations B and C required 22-30% less energy and 88% less photoinitiator compared to the standard.

A photoinitiator package “ladder” was evaluated in order to determine performance maxima for each formulation. The benchmark, Formulation A, required exogenous photoinitiator at the “standard loading” to yield tack-free cure. However, the inventive formulations gave tack-free cure at higher radiation doses in the absence of exogenous photoinitiator and cured tack-free at low radiation doses in the presence of small amounts of exogenous photoinitiator. The photoinitiator packages are detailed in Table III.

TABLE III
Photoinitiator “Ladder.”

| Initiator Package | Ingredients* | Parts (w/w) |
|---|---|---|
| Standard | SR1129 | 5.0 |
| | SR1137 | 3.0 |
| ½ PI | SR1129 | 2.5 |
| | SR1137 | 1.5 |
| ¼ PI | SR1129 | 1.25 |
| | SR1137 | 0.75 |
| ⅛ PI | SR1129 | 0.625 |
| | SR1137 | 0.375 |
| no PI | No photoinitiator added | |

The photoinitiators are standard products of Sartomer Company: SR1129 is a mixture of oligomeric 2-hydroxy-2-methyl-1[-4-(1-methylvinyl)]phenyl-1-propanone and 2-hydroxy-2-methyl-1-phenyl-1-propanone; SR1137 is a mixture of 2,4,6-trimethylbenzophenone and 4-methylbenzophenone.

TABLE IV
Wood Coating Formulations Containing
Michael Resins Cured in Air.

| | | Compara- | | |
|---|---|---|---|---|
| | | tive Fomu- | | |
| Component/Formulation | | lation A | B | C |
| CN964E75 urethane diacrylate, | | 49.9 | — | — |
| diluted with 25% SR454 | | | | |
| SR306 tripropylene glycol diacrylate | | 12.0 | — | — |
| SR344 polyethylene glycol (400) | | 7.0 | — | — |
| diacrylate | | | | |
| SR454 ethoxylated trimethylolpropane | | 9.0 | — | — |
| triacrylate | | | | |
| SR9003 propoxylated neopentyl | | 11.0 | — | 11.0 |
| glycol diacrylate | | | | |
| SR399 dipentaerythritol | | 3.0 | — | — |
| 7037-102 | | — | 100 | — |
| 7037-107 | | — | — | 89.0 |
| Viscosity, cP @ 25° C. | | 1350 | 1800 | 1900 |
| Minimum Dose (mJ/cm²) | | No cure | 1070 | 520 |
| to Tack-Free Cure | | | | |
| No Photoinitiator | | | | |
| Minimum Dose (mJ/cm²) | | No cure | 310 | 345 |
| to Tack-Free Cure | | | | |
| ⅛ Photoinitiator | | | | |
| Minimum Dose (mJ/cm²) | | No cure | 155 | 260 |
| to Tack-Free Cure | | | | |
| ¼ Photoinitiator | | | | |
| Minimum Dose (mJ/cm²) | | 1500 | 105 | |
| to Tack-Free Cure | | | | |
| ½ Photoinitiator | | | | |
| Minimum Dose (mJ/cm²) | | 440 | | |
| to Tack-Free Cure | | | | |
| Standard Photoinitiator | | | | |
| Cross Hatch Adhesion | To Red Oak | 0B | 5B | 4B-5B |
| (Permacel 99 tape) | To Poplar | 3B-5B | 5B | 5B |
| Cross Hatch Adhesion | To Red Oak | 0B | 5B | 4B-5B |
| (3M 600 tape) | To Poplar | 3B-4B | 4B-5B | 3B-5B |

| | | | |
|---|---|---|---|
| Sward hardness | 10 | 8-9 | 8-9 |
| Nail scratch adhesion | Pass | Pass | Pass |
| MEK double rubs | >200 | >200 | >200 |
| Gloss | High | High | High |

### EXAMPLE 2

### Wood Coating Formulations of Michael Resins Cured Under Nitrogen

Oxygen is known to inhibit free-radical polymerizations such as represented by the acrylate polymerizations of the present discussion. In the absence of oxygen, the present invention confers the dual advantage of yielding tack-free cure both in the absence of exogenous photoinitiator and at a radiation dose at least an order of magnitude less than that required by conventional resins. Lower radiation dose requirements may translate into faster line-speeds, thus increased productivity, and/or lower energy costs for a given unit of production.

Oxygen may be excluded by applying and curing the inventive resins and coatings under an inert atmosphere. A preferred inert atmosphere is a blanket of nitrogen. Suitable inert atmospheres include, but are not limited to carbon dioxide, and noble gasses, including helium, neon, and argon.

These advantages are illustrated in Table V. Comparative Formulation A and inventive Formulations B and C were applied to wood substrates and cured under a 600 W/in lamp under a nitrogen atmosphere. Inventive Formulations B and C required a UV dose of 120-140 mJ/cm² to cure tack-free in the absence of added photoinitiator.

TABLE V
Wood Coating Formulations Containing
Michael Resins Cured Under Nitrogen.

| | Comparative | | |
|---|---|---|---|
| Component/Formulation | Formulation A | B | C |
| CN964E75 urethane | 49.9 | — | — |
| diacrylate, diluted with 25% | | | |
| SR454 | | | |
| SR306 tripropylene glycol | 12.0 | — | — |
| diacrylate | | | |
| SR344 polyethylene glycol | 7.0 | — | — |
| (400) diacrylate | | | |
| SR454 ethoxylated | 9.0 | — | — |
| trimethylolpropane triacrylate | | | |
| SR9003 propoxylated | 11.0 | — | 11.0 |
| neopentyl glycol diacrylate | | | |
| SR399 dipentaerythritol | 3.0 | — | — |
| tetraacrylate | | | |
| 7037-102 | — | 100 | — |
| 7037-107 | — | — | 89.0 |
| Viscosity, cP @ 25° C. | 1350 | 1800 | 1900 |
| Minimum Dose (mJ/cm²) | 1430 | 120 | 140 |
| to Tack-Free Cure on Poplar | | | |
| No Photoinitiator | | | |
| Minimum Dose (mJ/cm²) | 1610 | 137 | 137 |
| to Tack-Free Cure on Red | | | |
| Oak | | | |
| No Photoinitiator | | | |

### EXAMPLE 3

### Polyester Acrylate-Based Michael Resins

An aspect of the present invention provides polyester acrylate-based Michael resins that include at least one low molecular weight polyester acrylate and at least one secondary amine. An acrylate mixture is mixed, at a preferred molar ratio of 2.6 moles of total acrylate to 1.0 mole of at least one β-dicarbonyl compound and further with a secondary amine. The amine is added at a preferred molar ratio of 0.36 relative to the Michael donor. A Michael resin is formed by reaction in the presence of a strong base catalyst. A preferred strong base catalyst is diazabicycloundecene (DBU).

Formulations D and E (Table VI) were chosen as the comparative standards. Exemplary inventive Formulations F and G were formed by selectively replacing the polyester acrylate oligomer of the comparative formulations with Michael addition oligomer 7009-003 (Table I). The photoinitiator used in inventive formulations F and G was Irgacure 184, in place of Darocur 1173 used in the comparative formulations. Irgacure 184 and Darocur 1173 are known in the art to have essentially identical photo-response characteristics. Similar concentrations are known to yield similar cure responses.

To measure cure response, formulations were put into a depth gauge, graduated to 1000 microns. Cure was effected with an American Ultraviolet 300 W/in medium pressure Hg vapor lamp fitted with an elliptical reflector. The depth of cure was measured, and the UV dosage required to cure to a depth of 1000 microns was recorded.

To measure the surface properties of coatings on wood substrates, formulations were applied to substrate panels in six passes, yielding an overall coating thickness of 1-3 mils. Each layer was cured tack-free after each application of resin. This procedure simulated three coats of sealer and three coats of topcoat. Applications 1, 2, 4, and 5 were cured with UV doses of 242-310 mJ/cm². Applications 3 and 6 were cured with a UV dose of 743 mJ/cm². The substrate was an oak-veneer wood flooring-panel coated with an aqueous stain and UV filler.

TABLE VI
(components in parts by weight). Wood Coating Formulations
Containing Michael Resin Based on Polyester Acrylate.

| | Comparative | Comparative | | |
|---|---|---|---|---|
| Component/Formulation | Formulation D | Formulation E | F | G |
| Laromer PE55F polyester acrylate | 24.9 | 49.9 | | |
| (BASF) | | | | |
| Laromer PE44F polyester acrylate | 24.9 | | | |
| (BASF) | | | | |
| Ebecryl 264 aliphatic urethane | 15.1 | 15.0 | | |
| triacrylate diluted with 15% HDDA | | | | |
| (Surface Specialties/UCB | | | | |
| Chemicals) | | | | |
| Laromer HDODA 1.6-hexanediol | 11.0 | 11.0 | 11.4 | 11.4 |
| diacrylate (BASF) | | | | |
| Sartomer SR344 polyethylene | 19.9 | 19.9 | 20.6 | |
| glycol (400) diacrylate (Sartomer | | | | |
| Company) | | | | |
| 7009-003 | | | 67.1 | 87.8 |
| Tego Wet 500 wetting agent | 1.0 | 1.0 | 0.3 | 0.3 |
| (Goldschmidt Chemical Corp.) | | | | |
| Airex 920 deaerating agent | 0.2 | 0.2 | 0.05 | 0.04 |
| (Goldschmidt Chemical Corp.) | | | | |
| Darocur 1173 liquid photoinitiator | 3.0 | 3.0 | | |
| Irgacure 184 crystalline | | | 0.5 | 0.5 |
| photoinitiator (Ciba Specialty | | | | |
| Chemicals Inc.) | | | | |
| Viscosity, cP at 25° C. | 700 | 1180 | 900 | 2350 |
| UV dosage required for 1000 micron | 257 | 247 | 252 | 252 |
| depth of cure, mJ/cm² | | | | |
| Properties after coating wood substrate: | | | | |
| Acetone Resistance | slight lift | | no | no |
| | | | effect | effect |
| Iodine Stain* | 4-5 | | 5 | 4.5 |

*0 = no stain, 5 = heavy stain (all stains bleached to a value of about 1 after two days)

Inventive formulations, F and G each cured to a depth of 1000 microns at a dosage of about 252 mJ/cm². Moreover, full cure was achieved in the presence of 83% less photoinitiator in comparison to the conventional formulations.

### EXAMPLE 4

### Michael Resins Suitable for Use in Fillers for Particle Board

In this example, particle board filler formulation H (Table VII) was prepared by blending 60 parts by weight Michael oligomer 7077-103 (Table I) and 40 parts by weight calcium carbonate. No photoinitiator additive was used. Formulation H was coated onto particle board to a 2 mil thickness and cured by irradiating with 1000 mJ/cm² of UV light from a 600 W/in Fusion “H” bulb. Formulation H yielded good performance on particle-board.

Addition of particulate filler to a hardenable resin increases formulation body, improves cured wood filler sandability and hardness, and reduces cost. Calcium carbonate is a preferred, but non-limiting particulate filler material. Suitable materials include, but are not limited to talc, titanium dioxide (such as rutile and anastase), alkali alumino silicate solid microspheres (3M Zeeospheres™), silica, kaolin and other clays, and wood flour.

TABLE VII
Formulation and Properties of a Particle Board Filler.

| Component/Formulation | H |
|---|---|
| 7077-103 | 60.0 |
| Hubercarb Q6 calcium carbonate | 40.0 |
| Viscosity, cP at 25° C. | 13650 |
| Depth of Cure at 1000 mJ/cm² UV dosage, mils | 15 |
| Cross Hatch Adhesion to Particle Board | 5B |
| (Permacel 99 tape) | |
| MEK Double Rubs | >200 |
| Pencil Hardness | 4H |
| Sandability (100 grit paper) | Good, does not |
| | clog paper |

An aspect provides that the inventive coating compounds are optimized for use on wood substrates. However, the invention is not limited to wood substrates.

The foregoing description of the invention illustrates and describes the present invention. Additionally, the disclosure shows and describes only the preferred embodiments of the invention but, as mentioned above, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described herein are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

### INCORPORATION BY REFERENCE

All publications, patents, patent application publications, and ASTM test method publications cited in this specification are herein incorporated by reference, and for any and all purposes, as if each individual publication, patent, patent application publication, and/or ASTM test method publication were specifically and individually indicated to be incorporated by reference. In the case of inconsistencies the present disclosure will prevail. Specifically co-pending applications serial numbers (not yet assigned; attorney docket numbers 20435-141, 20435-144, 20435-145, 20435-146, 20435-147, 20435-148, and 20435-152) are hereby incorporated by reference for any and all purposes.

TABLE VIII
Preferred Embodiments of Coating Compositions For Wood
Substrates.

| | Composition | | | | |
|---|---|---|---|---|---|
| | B | C | F | G | H |
| | Parts | Parts | Parts | Parts | Parts |
| Component | (wt) | (wt) | (wt) | (wt) | (wt) |
| 7037-102 | 100 | — | — | — | — |
| 7037-107 | — | 89.0 | — | — | — |
| 7009-103 | — | — | 67.1 | 87.8 | — |
| 7077-103 | — | — | — | — | 60.0 |
| propoxylated neopentyl glycol | — | 11.0 | — | — | — |
| diacrylate | | | | | |
| 1,6-hexanedioldiacrylate | — | — | 11.4 (a) | 11.4 (a) | — |
| (HDODA; HDDA) | | | | | |
| polyethylene glycol (400) | — | — | 20.6 | — | — |
| diacrylate | | | | | |
| Tego Wet 500 (b) | — | — | 0.3 | 0.3 | |
| Airex 920 I | — | — | 0.05 | 0.04 | — |
| Irgacure 184 (e) | — | — | 0.5 | 0.5 | — |
| Calcium carbonate | — | — | — | — | 40.0 |

(a) HDDA also incorporated into Michael resin.
(b) Tego Wet 500 (™ Goldschmidt Chemical Corp.).
(c) Airex 920 (™ Goldschmidt Chemical Corp.).
(d) Darocur 1173 (™ Ciba Specialty Chemicals, Inc.).
(e) Irgacure 184 (™ Ciba Specialty Chemicals, Inc.).

All parts given as parts by weight.

1. A UV-curable Michael resin composition for a wood substrate comprising the resinous Michael addition product of a β-dicarbonyl compound and a Lewis-functional multifunctional acrylate ester wherein said resin has a surface tension in the range of from about 45 to about 70 dynes/cm.

2. The UV-curable Michael resin composition for a wood substrate, according to claim 1, further comprising the Michael addition of at least two Lewis-functional multifunctional acrylate ester.

3. The UV-curable Michael resin composition for a wood substrate, according to claim 1, wherein said Lewis-functional multifunctional acrylate ester comprises a chemical moiety selected from the group consisting of hydroxyl, epoxy, amine, acid, urethane, melamine, ester and mixtures thereof.

4. The UV-curable Michael resin composition for a wood substrate, according to claim 1, wherein said Lewis-functional moieties are present from about 0.5 to about 1.5 moieties per 100 molecular weight.

5. The UV-curable Michael resin composition for a wood substrate, according to claim 1, wherein said β-dicarbonyl compound is selected from the group consisting of β-keto esters, β-diketones, β-keto amides, β-keto anilides, and mixtures thereof.

6. The UV-curable Michael resin composition for a wood substrate, according to claim 5, wherein a preferred β-dicarbonyl is a β-diketone.

7. The UV-curable Michael resin composition for a wood substrate, according to claim 6, wherein a preferred β-diketone is 2,4-pentanedione.

8. The UV-curable Michael resin composition for a wood substrate, according to claim 5, wherein a preferred β-dicarbonyl is a β-ketoester.

9. The UV-curable Michael resin composition for a wood substrate, according to claim 8, wherein a preferred β-ketoester is ethyl acetoacetate.

10. The UV-curable Michael resin composition for a wood substrate, according to claim 1, further comprising a particulate filler.

11. The UV-curable Michael resin composition for a wood substrate, according to claim 10, wherein said particulate filler comprises a material selected from the group consisting of calcium carbonate, talc, titanium dioxide, alkali alumino silicate, colloidal silica, kaolin, clay, wood flour, and mixtures thereof.

12. The UV-curable Michael resin composition for a wood substrate, according to claim 1, further comprising an amine-modified polyether acrylate.

13. The UV-curable Michael resin composition for a wood substrate, according to claim 1, further comprising a secondary amine.

14. The UV-curable Michael resin composition for a wood substrate, according to claim 1, wherein said secondary amine is selected from the group consisting of diethanolamine, piperidine diethylamine, di-n-butylamine, morpholine, N-methylethanolamine, piperazine, and mixtures thereof.

15. The UV-curable Michael resin composition for a wood substrate, according to claim 1, further comprising an epoxy acrylate.

16. The UV-curable Michael resin composition for a wood substrate, according to claim 15, wherein a preferred epoxy acrylate is an aromatic epoxy acrylate selected from the group consisting of bisphenol A epoxy acrylates and epoxy novolac acrylates.

17. The UV-curable Michael resin composition for a wood substrate, according to claim 1, further comprising at least one agent selected from the group consisting of flow and leveling additives, wetting agents, deaerating agents, photoinitiators, matting agents, colloidal silica, pigments, dyes, and mixtures thereof.

18. A method of using a UV-curable Michael resin composition for a wood substrate comprising:
providing a substrate;
providing a UV-curable coating composition comprising the resinous Michael addition product of a β-dicarbonyl compound and a Lewis-functional polyacrylate ester wherein said resin has a surface tension in the range of from about 45 to about 70 dynes/cm;
applying said composition to said substrate; and
curing said composition.

19. The method of using a UV-curable Michael resin composition for a wood substrate, according to claim 18, wherein applying said composition comprises a method selected from the group consisting of roll coating, spraying, brushing, and dipping.

20. The method of using a UV-curable Michael resin composition for a wood substrate, according to claim 18, wherein curing said composition comprises providing a radiation selected from the group consisting of visible light, ultraviolet light, and electron beam radiation.

21. The method of using a UV-curable Michael resin composition for a wood substrate, according to claim 18, further comprising providing an inert atmosphere.

22. The method of using a UV-curable Michael resin composition for a wood substrate, according to claim 18, wherein said composition further comprises at least one compound selected from the group consisting of amine-modified polyether acrylates, polyester acrylates, low molecular weight polyol acrylates, epoxy acrylate, and mixtures thereof.

23. The method of using a UV-curable Michael resin composition for a wood substrate, according to claim 18, wherein said composition further comprises at least one agent selected from the group consisting of fillers, flow and leveling additives, wetting agents, deaerating agents, photoinitiators, matting agents, colloidal silica, pigments, dyes, and mixtures thereof.

24. A substrate coated with the UV-curable composition for a wood substrate of claim 1.

25. A device loaded with the UV-curable composition for a wood substrate of claim 1.
